(19) United States
(12) Patent Application Publication
(10) Pub. No.: US 2008/0082830 A1
(43) Pub. Date: Apr. 3, 2008

(54) METHOD AND SYSTEM FOR DISPLAYING TRUST LEVEL ON A WIRELESS COMMUNICATION DEVICE

(75) Inventor: Walter P. Goulet, Chicago, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/536,775

(22) Filed: Sep. 29, 2006

(51) Int. Cl. H04L 9/00

(52) U.S. Cl. 713/177

(57) ABSTRACT

A method and system for displaying trust level on a wireless communication device (100) is provided. The method includes receiving (204) a list of trusted root authority certificates. The method further includes calculating the trust level of a local wireless communication network by determining (206) how at least one verifying root authority certificate was stored on the wireless communication device and if the at least one verifying root authority certificate is included in the list of trusted root authority certificates. Further, the method includes displaying (208) the trust level of the local wireless communication network at the wireless communication device.

### FIELD OF THE INVENTION

The present invention relates generally to the field of wireless communications, and more specifically, to the trust levels of wireless communication networks.

### BACKGROUND

Wireless communication devices are widely used for transmission of information or data in a wireless communication system. Information or data from a first wireless communication device can be communicated to a second wireless communication device through a wireless communication network. There exist a number of wireless communication networks, each providing different communication services. But a user may be unable to decide whether transmission of information or data using one of these wireless communication networks can be safe or not. Hence, it is necessary to assign a trust level to the wireless communication networks. The trust level of a wireless communication network may indicate reliability of the wireless communication network. Hence, an authenticating agency is required to assign a trust level to the different wireless communication networks.

Voice over Internet Protocol (VOIP) systems that interoperate with wireless communication systems have different authentication mechanisms than those used in traditional cellular network technologies such as Global System for Mobile Communications (GSM). Some of the known methods for authenticating a wireless communication network use Public Key Infrastructure (PKI) based authentication. PKI authentication method is based on the use of public key cryptography and digital signatures. A master public/private key pair known as the root certificate and root signing key is created by an entity acting as a Certificate Authority. The data that is encrypted can be decrypted only with the use of a corresponding private/public key. This property of public/private key pairs is utilized in PKI. A root signing key is used to sign certificates that are issued to other entities that the root authority is willing to vouch for. The root certificate (the root public key) is distributed to a wide set of users and installed on their devices. Then, when an end-user device is presented with a certificate, it uses the installed root certificate to check if the certificate was signed by the root private key. If it was indeed signed by the root private key, the device can trust the certificate. The PKI authentication method is further based on the concept of trusting a set of root authorities. A device that utilizes PKI is configured with a set of certificates owned by the root authorities trusted by the device. These root authorities vouch for the identity of networks and the users of wireless communication devices in a tree-like fashion. For instance, a first root authority can vouch for the identity of a second root authority. The second root authority can further issue certificates to the networks and users of wireless communication devices and so on. The PKI authentication method ensures confidentiality and security of electronic transactions.

This set of root authority certificates can usually be modified by the MS user to accommodate multiple wireless communication networks. The PKI model usually requires a certain level of user interaction, for instance, when a web browser is directed to a website with an untrusted certificate. Frequently, users cannot make informed decisions while deciding whether or not to trust a certificate. Therefore, a user of the wireless communication device may be confused or at least misled into assigning more trust to a given wireless communication network than the actual trust level of the wireless communication network. Therefore, by using such authentication methods the user of the wireless communication device may not be able to know the trust level of the wireless communication device.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with various embodiments of the present invention.

FIG. 1 representatively shows a block diagram of a wireless communication device, in accordance with various embodiments of the present invention;

FIG. 2 represents a flow diagram depicting a method for displaying a trust level at a wireless communication device, in accordance with an embodiment of the present invention;

FIG. 3 represents a flow diagram depicting a method for displaying a trust level at a wireless communication device, in accordance with another embodiment of the inventive arrangements of the present invention; and

FIG. 4 shows an exemplary block diagram illustrating the different trust levels that can be displayed at the wireless communication device and updating of the list of trust certificates at the wireless communication device by an administrator of the wireless communication network, in accordance with some embodiments of the inventive arrangements of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

A method for displaying a trust level of a local wireless communication network at a wireless communication device is provided, in accordance with various embodiments the present invention. The wireless communication device is capable of storing at least one verifying root authority certificate. Further, one of the installed root authority certificates is used to verify the authenticity of a certificate presented by the local wireless communication network. The method comprises receiving a list of trusted root authority certificates from a trusted entity in a wireless communication network. The method further comprises calculating the trust level of the local wireless communication network by determining how the verifying root authority certificate was stored on the wireless communication device and checking to determine if the verifying root authority certificate was included in the list of trusted root authority certificates. The method further comprises displaying the trust level of the local wireless communication network at the wireless communication device.

A wireless communication device that is capable of displaying a trust level of a local wireless communication network is provided, in accordance with various embodiments of the present invention. The wireless communication device stores at least one verifying root authority certificate. Further, the verifying root authority certificate is used to verify the authenticity of certificate presented by the local wireless communication network. The wireless communication device comprises a transceiving unit for receiving a list of trusted root authority certificates from a trusted entity in a wireless communication network. The wireless communication device further comprises a processor capable of calculating the trust level of the local wireless communication network by determining how the verifying root authority certificate was stored on the wireless communication device and checking to determine if the verifying root authority certificate was included in the list of trusted root authority certificates. The wireless communication device further comprises a display for displaying the trust level of the local wireless communication network at the wireless communication device.

Before describing in detail the particular method and system for displaying trust level on a wireless communication device in accordance with the present invention, it should be observed that the present invention resides primarily in combinations of method steps and apparatus components related to method and system for displaying trust level on a wireless communication device. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

A “set” as used in this document, means a non-empty set (i.e., comprising at least one member). The term “another”, as used herein, is defined as at least a second or more. The term “including” as used herein, is defined as comprising.

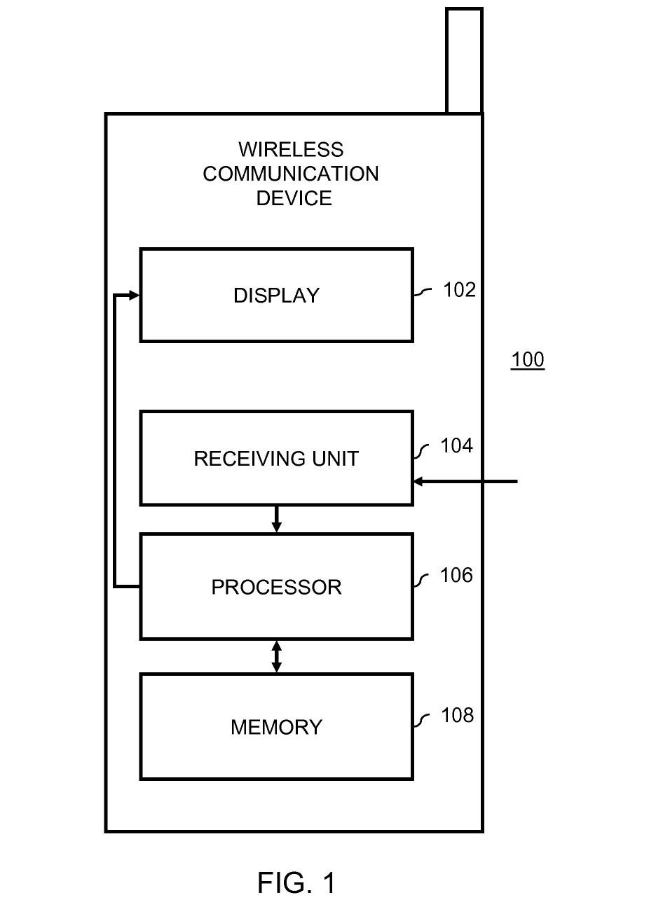

FIG. 1 representatively shows a block diagram of a wireless communication device 100, in accordance with various embodiments the present invention. Examples of the wireless communication device 100 include, but are not limited to, a mobile phone, a Personal Digital Assistant (PDA), and so forth. The wireless communication device 100 can be used for communicating information or data in a wireless communication system.

The wireless communication device 100 includes a display 102, a transceiving unit 104, and a processor 106. The wireless communication device 100 stores at least one verifying root authority certificate. The verifying root authority certificate can be used to verify the authenticity of the certificate presented by the local wireless communication network. In accordance with some embodiments of the present invention, the wireless communication device 100 stores the verifying root authority certificate of the local wireless communication network in a memory 108 of the wireless communication device 100. The at least one verifying root authority certificate stored at the wireless communication device 100 can further be used to indicate the trust level of the wireless communication network. For an embodiment of the present invention, the verifying root authority certificate can be stored in the memory 108 of the wireless communication device 100 by a manufacturer of the wireless communication device 100. The display 102 of the wireless communication device 100 is used to display different types of information pertaining to the wireless communication device 100. The display 102 can be used to display the trust level of the local wireless communication network, in accordance with various embodiments of the invention. The transceiving unit 104 receives a list of trusted root certificates from a trusted entity in a wireless communication network. For an embodiment of the present invention, the transceiving unit 104 can download a list of trusted root certificates for the local wireless communication networks. The wireless communication device 100 can use the list of trusted root certificates and the verifying root authority certificate for assigning a trust level to the local wireless communication network. In accordance with some embodiments of the present invention, trust levels can be assigned to the local wireless communication network by a trusted entity.

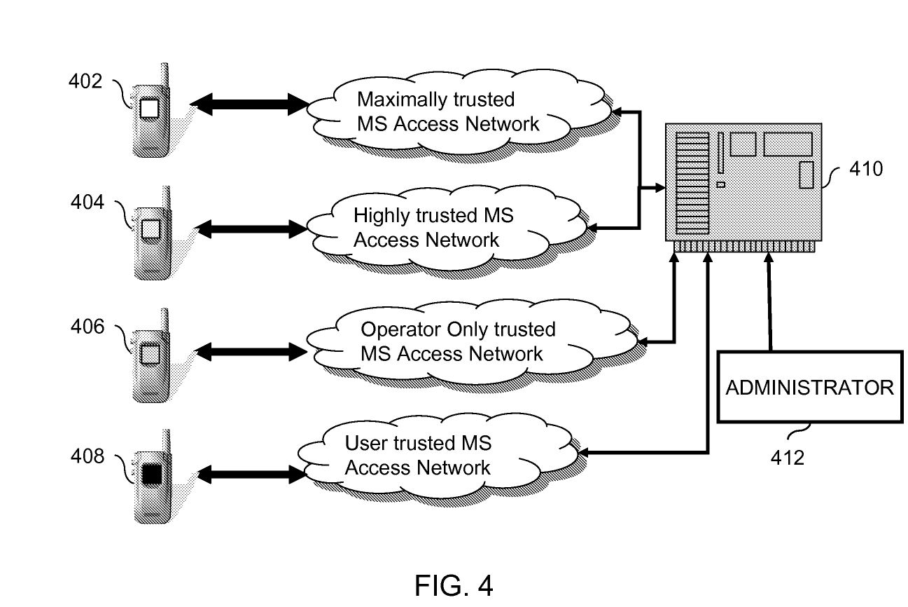

The list of trusted root certificates indicates a first trust level of the local wireless communication network. The processor 106 of the wireless communication device 100 is coupled to the transceiving unit 104. The processor 106 of the wireless communication device 100 calculates the trust level of the local wireless communication network, based on a comparison between the verifying root authority certificate of the local wireless communication network and the list of trusted root certificates. Further, the processor 106 of the wireless communication device 100 validates the verifying root authority certificate of the local wireless communication network. The processor 106 validates the verifying root authority certificate of the local wireless communication network by checking whether the trusted root certificate has expired or not and optionally whether or not another trusted root authority has signed it. The memory 108 can be used to store the verifying root authority certificate of the local wireless communication network and the list of trusted root certificates. In accordance with some embodiments of the inventive arrangements of the invention, the wireless communication device 100 may include a user interface for selecting the local wireless communication network, in response to the trust level of the local wireless communication network. Hence, when the user of the wireless communication device 100 enters a local wireless communication network, a trust level of the local wireless communication network is displayed on the display 102. Further, the user of the wireless communication device 100 can select the local wireless communication network by using the user interface. For another embodiment of the present invention, each of the trust level displayed at the wireless communication device 100 can be assigned a different color. For another embodiment of the present invention, an icon can represent different trust levels of the local wireless communication network at the wireless communication device 100. The different colors and icons of trust levels are further explained in conjunction with FIG. 4.

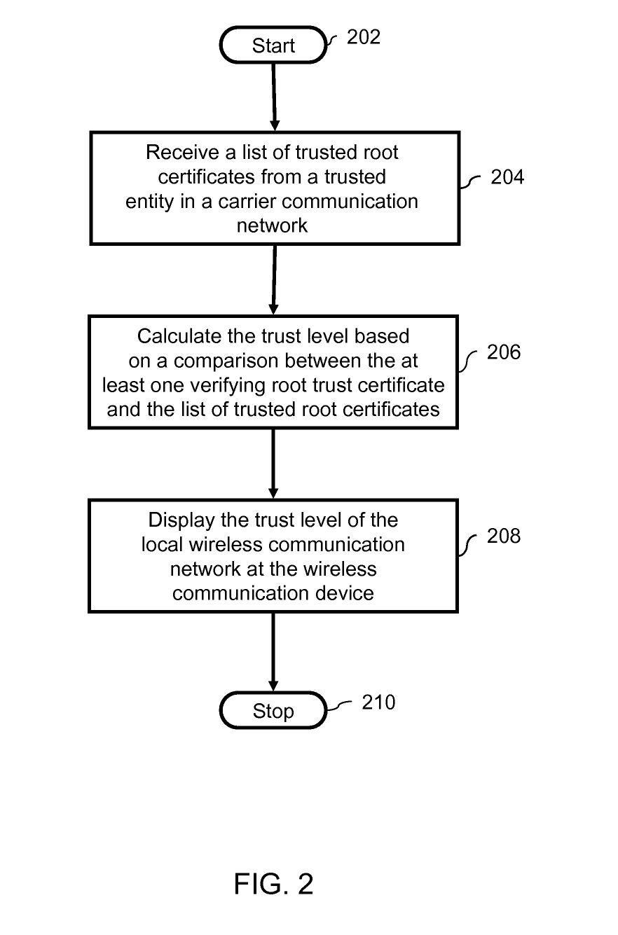

FIG. 2 represents a flow diagram depicting a method for displaying a trust level on the wireless communication device 100, in accordance with an embodiment of the present invention. The wireless communication device 100 stores at least one root authority certificate. The root authority certificate can be used to verify the authenticity of a certificate presented by the local wireless communication network. Once one of the root authority certificates installed on the wireless communication device 100 has verified the certificate presented by the local wireless communication network, that root certificate becomes a verifying root authority certificate of the local wireless communication network. The method for displaying a trust level at a wireless communication device 100 starts at step 202. At step 204, the wireless communication device 100 receives a list of trusted root certificates from a trusted entity in a carrier communication network. The list of trusted root certificates can be received by the transceiving unit 104 from the trusted entity at the wireless communication device 100.

At step 206, the wireless communication device 100 calculates the trust level of the local wireless communication network by comparing the verifying root authority certificate of the local wireless communication network with the list of trusted root certificates received by the wireless communication device 100 at step 204. For one embodiment of the present invention, the trust level can be calculated by the processor 106 of the wireless communication device 100. For another embodiment of the present invention, the list of trusted root certificates may indicate a first trust level of the local wireless communication network. The wireless communication device 100 may also validate the at least one verifying root authority certificate of the local wireless communication network. At step 208, the trust level of the local wireless communication network is displayed at the wireless communication device 100. For an embodiment of the present invention, the trust level of the local wireless communication network can be displayed on the display 102 of the wireless communication device 100. The user of the wireless communication device 100 can select the local wireless communication network based on the trust level of the wireless communication device.

Examples of a trust levels include, but are not limited to, a maximum trust level, a high trust level, an operator trust level and a user trust level. These trust levels may assist a user of the wireless communication device 100 to decide whether connect to a local wireless communication network. A maximum trust level is displayed at the wireless communication device 100 when the verifying root authority certificate is stored at the wireless communication device by a wireless communication device manufacturer and the verifying root authority certificate is present in the list of trust certificates. A high trust level can be displayed at the wireless communication device 100 when the verifying root authority certificate of the local wireless communication network is stored at the wireless communication device 100 by the wireless communication device manufacturer and verifying root authority certificate is absent in the lost of trust certificates. An operator trust level is displayed at the wireless communication device 100 when the verifying root authority certificate of the local wireless communication network is stored at the wireless communication device 100 by a wireless communication device user and the verifying root authority certificate is present in the list of trust certificates. A user trust level is displayed at the wireless communication device 100 when the verifying root authority certificate of the local wireless communication network is stored at the wireless communication device 100 by the wireless communication device user and the verifying root authority certificate is absent in the list of trust certificates.

The user of the wireless communication device 100 can decide whether to connect to a local wireless communication network based on the trust level of the local wireless communication network. The method for displaying a trust level at a wireless communication device 100 stops at step 210. In case when more than one local wireless communication network is present, the user of the wireless communication device 100 can select the wireless communication network that has the maximum trust level. Further, the user can select the local wireless communication network by using the user interface at the wireless communication device 100. For one embodiment of the present invention, the list of trust certificates at the wireless communication device 100 can be updated by a wireless communication network administrator.

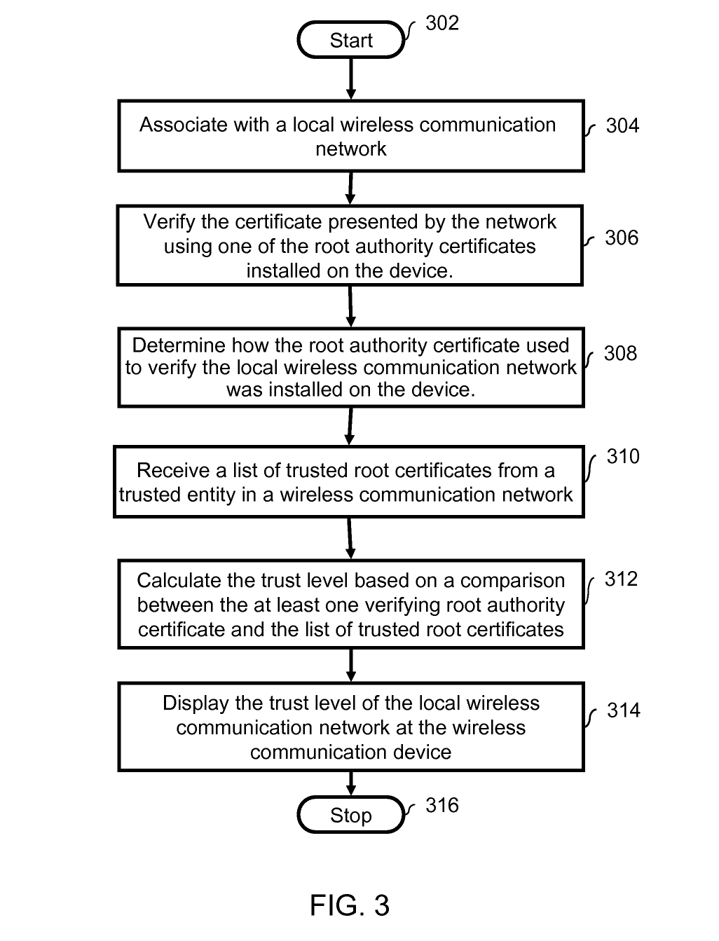

FIG. 3 represents a flow diagram depicting a method for displaying a trust level on the wireless communication device 100, in accordance with another embodiment of the inventive arrangements of the present invention. The wireless communication device 100 stores at least one root authority certificate. The root authority certificate can be used to verify the authenticity of a certificate presented by the local wireless communication network. Once one of the root authority certificates installed on the wireless communication device 100 has verified the certificate presented by the local wireless communication network, that root certificate becomes a verifying root authority certificate of the local wireless communication network. The method for displaying a trust level at a wireless communication device 100 starts at step 302. At step 304, the wireless communication device 100 associates with a local wireless communication network. For one embodiment of the present invention, the user of the wireless communication device 100 can manually select the local wireless communication network for the wireless communication device 100. The user of the wireless communication device 100 can select the local wireless communication device by using the user interface of the wireless communication device 100. At step 306, the wireless communication device 100 verifies the certificate presented by the network by using one of the root authority certificate installed on the wireless communication device 100. Verifying the at least one verifying root authority certificate of the local wireless communication network further includes checking whether the trust certificate has been signed by a trusted entity in the wireless communication system.

At step 308, the wireless communication device 100 determines the way in which the root authority certificate used to verify the local wireless communication network was installed on the wireless communication device 100. The wireless communication device 100 checks whether the at least one verifying root authority certificate was installed by the wireless communication device manufacturer of the wireless communication device 100 or by the user of the wireless communication device 100. For an embodiment of the present invention, when the user of the wireless communication device 100 contacts a local wireless communication network, it is presented with a verifying root authority certificate of the local wireless communication network. The wireless communication device 100 then checks the list of trusted root certificates stored at the wireless communication device 100 for the trusted root certificate of the local wireless communication network. If the trusted root certificate of the local wireless communication network is signed by at least one of a verifying root authority, the local wireless communication network is assigned a high trust level. For another embodiment of the present invention, the wireless communication device 100 can download a list of certificates from an application server at the wireless communication device 100. The wireless communication device 100 checks the list of trusted root certificates for the trusted root certificate of the local wireless communication network. If the trusted root certificate of the local wireless communication network is present in the list of trusted root certificates at the wireless communication device 100, the local wireless communication network can be trusted by the user and the user can safely connect to the local wireless communication network.

At step 310, the wireless communication device 100 receives a list of trusted root certificates for the local wireless communication networks from a trusted entity in the wireless communication system. The list of trusted root certificates can be a list of local wireless communication networks along with their assigned trust levels. In accordance with some embodiments of inventive arrangements of the invention, the trust levels can be assigned to the local wireless communication networks by the trusted entity. At step 312, the wireless communication device 100 calculates the trust level of the local wireless communication network by comparing the at least one verifying root authority certificate of the local wireless communication network with the list of trusted root certificates received by the wireless communication device 100 at step 310. For one embodiment of the present invention, the trust level can be calculated by the processor 106 of the wireless communication device 100. For another embodiment of the present invention, the list of trust certificates may indicate a first trust level of the local wireless communication network.

At step 314, the trust level of the local wireless communication network is displayed at the wireless communication device 100. For an embodiment of the present invention, the trust level of the local wireless communication network can be displayed on the display 102 of the wireless communication device 100. The user of the wireless communication device 100 can select the wireless communication network based on the trust level of the wireless communication device. A maximum trust level is displayed at the wireless communication device 100 when the at least one verifying root authority certificate is stored at the wireless communication device by a wireless communication device manufacturer and the at least one verifying root authority certificate is present in the list of trust certificates. A high trust level can be displayed at the wireless communication device 100 when the at least one verifying root authority certificate of the local wireless communication network is stored at the wireless communication device 100 by the wireless communication device manufacturer and the at least one verifying root authority certificate is absent in the list of trust certificates. An operator trust level is displayed at the wireless communication device 100 when the at least one verifying root authority certificate of the local wireless communication network is stored at the wireless communication device 100 by a wireless communication device user and the at least one verifying root authority certificate is present in the list of trust certificates. A user trust level is displayed at the wireless communication device 100 when the at least one verifying root authority certificate of the local wireless communication network is stored at the wireless communication device 100 by the wireless communication device user and the at least one verifying root authority certificate is absent in the list of trust certificates. The method for displaying a trust level at a wireless communication device ends at step 316. The user of the wireless communication device 100 can decide whether to connect to a local wireless communication network based on the trust level of the local wireless communication network. If more than one local wireless communication is present, the user of the wireless communication device 100 can decide to connect to a particular wireless communication network based on the trust level of various local wireless communication networks.

FIG. 4 shows an exemplary block diagram illustrating the different trust levels that can be displayed at the wireless communication device 100 and updating of the list of trust certificates at the wireless communication device 100 by an administrator of the wireless communication network, in accordance with some embodiments of the inventive arrangements of the present invention. In an embodiment, different color codes may be assigned to the earlier mentioned trust levels of the local wireless communication networks displayed at the wireless communication device 100 to quickly indicate the trust level to the user of the device. Four wireless communication devices, 402, 404, 406 and 408 are illustrated, showing a maximum trust level, a high trust level, an operator trust level and a user trust level, respectively, for different local wireless communication networks. For an exemplary embodiment, the wireless communication device 402 may signify a maximally trusted local wireless communication network using a white display. A highly trusted local wireless communication network can be signified by the wireless communication device 404 using a light gray display. For indicating an operator trusted local wireless communication network, the wireless communication device 406 can use a dark gray display. The wireless communication device 408 may display a user trusted local wireless communication network using a black display. A wireless communication network server 410 has also been illustrated. The wireless communication network server 410 can update the list of trust certificates at the wireless communication device 100. For one embodiment of the present invention, the list of trust certificates at the wireless communication server 410 can be revised by a wireless communication system administrator 412. Further, the wireless communication network server 410 can be managed by a wireless communication system administrator 412 for updating the list of trust certificate of the local wireless communication networks.

For one embodiment of the present invention, different icons can be assigned to different trust levels of the local wireless communication networks. These icons and colors, representing the trust levels of a local wireless communication network, can be displayed on the displaying device 102 of the wireless communication device 100.

In accordance with some embodiments of the present invention, if the user of the wireless communication device 100 displays an operator trust level of a local wireless communication network, a warning message can be displayed to the user. For another embodiment of the present invention, if the wireless communication device 100 is operating in an operator trust level, the user can be warned of the same using a text message. Further, the user of the wireless communication device 100 can be informed of a local wireless communication network with higher trust level. An exemplary warning or text message that can be displayed to the user of the wireless communication device 100 may be ‘Please note that you are operating in an operated trust level local wireless communication network. A local communication network with a higher trust level is also available’. For another embodiment of the present invention, the user of the wireless communication device 100 can select another local wireless communication network with higher trust level using the user interface of the wireless communication device 100.

Various embodiments of the present invention display the trust level of the local wireless communication network on the wireless communication device, thereby enabling the user of the wireless communication device to select a secure local wireless communication network. Further, the user is informed whether a local wireless communication network is not secure and can take necessary action.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for displaying a trust level of a local wireless communication network at a wireless communication device, the wireless communication device storing at least one verifying root authority certificate that was used to verify the authenticity of the certificate presented by the local wireless communication network, the method comprising:
receiving a list of trusted root authority certificates from a trusted entity in a carrier communication network;
calculating the trust level of the local wireless communication network by determining how the at least one verifying root authority certificate was stored on the wireless communication device and checking to determine if the at least one verifying root authority certificate was included in the list of trusted root authority certificates; and
displaying the trust level of the local wireless communication network at the wireless communication device.

2. The method of claim 1 further comprising selecting the local wireless communication network in response to the trust level of the local wireless communication network.

3. The method of claim 1, wherein the list of trust certificates indicates a first trust level of the local wireless communication network.

4. The method of claim 1, wherein displaying the trust level comprises displaying a maximum trust level for the local wireless communication network when the at least one verifying root authority certificate is stored at the wireless communication device by a wireless communication device manufacturer and the at least one verifying root authority certificate is present in the list of trust certificates.

5. The method of claim 1, wherein displaying the trust level comprises displaying a high trust level for the local wireless communication network when the at least one verifying root authority certificate is stored at the wireless communication device by a wireless communication device manufacturer and the at least one verifying root authority certificate is absent in the list of trust certificates.

6. The method of claim 1, wherein displaying the trust level comprises displaying an operator trust level for the local wireless communication network when the at least one verifying root authority certificate is stored at the wireless communication device by a wireless communication device user and the at least one verifying root authority certificate is present in the list of trust certificates.

7. The method of claim 1, wherein displaying the trust level comprises displaying a user trust level for the local wireless communication network when the at least one verifying root authority certificate is stored at the wireless communication device by a wireless communication user and the at least one verifying root authority certificate is absent in the list of trust certificates.

8. The method of claim 1 further comprising updating the list of trust certificates of the local wireless communication network at the wireless communication device.

9. The method of claim 1, wherein displaying the trust level further comprises assigning a color to the trust level indicating the trust level of the local wireless communication network.

10. The method of claim 1, wherein displaying the trust level further comprises assigning an icon to the trust level indicating the trust level of the local wireless communication network.

11. A wireless communication device, wherein the wireless communication device stores at least one verifying root authority certificate for the local wireless communication network, the at least one verifying root authority certificate being used to verify the authenticity of the local wireless communication network, the wireless communication device comprising:
a transceiving unit for receiving a list of trusted root certificates from a trusted entity in a wireless communication network;
a processor coupled to the transceiving unit, wherein the processor being capable of calculating the trust level of the local wireless communication network by determining how the at least one verifying root authority certificate was stored on the wireless communication device and checking to determine if the at least one verifying root authority certificate was included in the list of trusted root authority certificates; and
a display for displaying the trust level of the local wireless communication network at the wireless communication device.

12. The wireless communication device of claim 11, wherein the list of trust certificates indicates a first trust level of the local wireless communication network

13. The wireless communication device of claim 11 further comprising a user interface for selecting the local wireless communication network in response to the trust level of the local wireless communication network.

14. The wireless communication device of claim 11 further comprising a memory for storing the list of trust certificates at the wireless communication device.
